(19) United States
(12) Patent Application Publication
(10) Pub. No.: US 2002/0075891 A1
(43) Pub. Date: Jun. 20, 2002

(54) Network assisted random access method

(76) Inventor: Slim Souissi, San Diego, CA (US)

Correspondence Address: MOTOROLA INC, 600 NORTH US HIGHWAY 45, LIBERTYVILLE, IL, 60048-5343, US

(21) Appl. No.: 09/738,427

(22) Filed: Dec. 16, 2000

(51) Int. Cl. H04B 7/212; H04L 12/413

(52) U.S. Cl. 370/442; 370/445

(57) ABSTRACT

Data communication apparatus and method wherein a communication channel is accessible to transmitting stations and to a controller with access to the channel according to a contention protocol. A number of test slots in a frame of recurring time slots are used to assess the extent of network loading and to arrive at a probability of access factor (“PAF”). The PAF is used to adjust the probability of access for the transmitting stations, especially during periods of high traffic, so as to reduce the incidence of collisions.

### FIELD OF THE INVENTION

The invention relates to allocation of shared communications resources among users that may attempt to communicate simultaneously. More specifically, a slotted ALOHA network using slotted ALOHA access progressively limits access of users as usage increases relative to capacity.

### BACKGROUND OF THE INVENTION

In various network configurations it is necessary for user devices to share available resources, such as communications time and/or bandwidth. The demand for resources may at times exceed the supply. In cellular telephone systems, local area networks and other situations in which user devices act independently, any one or more of the user devices may seek to transmit a message or message packet at any given time. At times, two or more devices attempt to transmit at the same time. Receiving devices may be unable to discriminate one transmission from the other. The multiple transmissions interfere and neither is successfully received. This effectively wastes the bandwidth used by the interfering messages.

According to one possible technique, a network can be configured with the assumption that multiple devices using it will conflict occasionally, and that when a conflict occurs, retransmission will be necessary. In a somewhat different technique, an attempt is made to reduce the possibility of conflicts. In that case, the devices are managed to reduce or eliminate the incidence of simultaneous interfering transmissions. This might involve self-imposed rules governing potential transmitting devices, a supervisory controller, preliminary signaling between senders and intended recipients and/or with a controller to reserve a future transmission time, etc. Where there is little or no management, the need to detect and correct conflicts or message collisions are tasks inherent in using the system. According to the technique in which there is more management, dealing with collisions is less of a burden, but adhering to the rules and any required preliminary communications and the like are burdens that may have an impact on capacity that is comparable to that resulting from collisions.

Some forms of communication involve resources that can be subdivided into component parts that can be used simultaneously by multiple users or user devices. Assuming random access to many simultaneously operable components, the probability of a conflict (collision) interfering with a given message is low, being generally the quotient of the number of components divided by the number of simultaneous attempts to transmit. Each component is more likely to be used exclusively by one user device at a time if there are a large number of simultaneously operable components.

There are various ways in which a medium might be divided into component parts that are effectively useable simultaneously. Available bandwidth might be divided into frequency bands in a frequency division multiple access arrangement (FDMA). Transmission time on particular frequency bands can be divided into time slots in a time division multiple access (TDMA) arrangement. A further possibility is code division multiple access (CDMA), wherein multiple messages are overlaid on each other in a frequency band, with each assigned and distinguished by a unique code sequence. The present invention is applicable to these and other sorts of media, which might comprise a single frequency channel which is accessed according to a TDMA mode or a single wideband frequency band accessed in a CDMA mode or a set of discrete frequency channels that are accessed in a frequency hopping mode, or another such technique that shares the resource among a plurality of potentially conflicting user devices.

In order to minimize the occurrence or the adverse effects of conflict, it is possible to impose rules or protocols. The rules may involve steps that the user devices are expected to undertake in particular situations. The rules may also assume the participation of a supervisory device operable to arbitrate or to allot the resources among user devices. Each rule or added level of management carries a cost in hardware investment, processing requirements and/or throughput and bandwidth.

A simple rule to reduce conflict might require, for example, that any user device seeking to transmit, first listen (receive) on a prospective channel and defer transmitting until the channel is found to be idle. If the rule requires that the channel be found to be idle for a predetermined time period before it is considered available, that idle time period is effectively wasted every time a transmission is attempted. The exemplary simple rule may not be entirely effective in any event. If traffic is high, for example, multiple user devices monitoring the same channel for lapse of the minimum idle period may all attempt to transmit at the end of an idle period. More involved rules may be more effective, but carry added overhead.

In a more complicated arrangement, the rules (or protocol) might require a device that seeks to transmit to obtain clearance from a supervisory control device before transmitting. The control device can allocate a resource to user devices that request it, in some order such as first-come, first-served. The controller might allocate a channel exclusively to the requesting user device for a specific time period, or could assign the requesting device to a repetitive time slot in a time division multiplex frame. The channel or slot can be made available for an incremental time, or for the duration of a message. Allocation of communications resources in this way requires supervisory processing hardware and software (the controller), and imposes a processing load on user devices to establish and comply with signaling procedures between the user devices and the controller. Like other possible solutions, this solution expends some of the available bandwidth or throughput capacity on dealing with contention. Even if the controller assignments are such that messages do not overlap or “collide” during assigned periods, collisions may nevertheless occur when multiple user device messages collide when signaling the controller in an effort to reserve a channel.

When two or more messages overlap or collide, it may not be possible to discriminate all or part of one message from the other. In that case neither message may be received successfully. If one message was in fact received, it may not be dependably known to have been received correctly. Both messages may need to be re-sent. In other situations one of two overlapping messages may overpower the other and be received dependably but at the expense of the other message. A communication medium or technique that is characterized by possible overlap and interference between user devices or messages (known as a “contention” network), must treat the possibility of interference as a given fact and take steps to compensate. For example, receiving devices may routinely send back acknowledgment messages or resend-request messages (sometimes called ACK/NAK messages) to the sending device, due to the possibility that the message did not arrive or was not received intact.

The foregoing discussion generally distinguishes between random networks in which devices are wholly free to send whenever the need arises, versus controlled networks in which devices reserve future time slots where collisions do not occur. Hybrid arrangements are also possible. For example, in a full duplex network arrangement, a controller can be provided to govern certain aspects of communications initiated by user devices. In such an arrangement it is possible, for example, to permit the devices to signal a controller over a contention channel to reserve a future non-contention channel or slot.

In U.S. Pat. No. 5,384,777—Ahmadi et al., for example, a MAC protocol is described in which a time slotted full duplex frame is subdivided between a message section and a signaling section. The signaling section is subject to contention and is used, among other functions, to signal a user device request for a time slot reservation. Once reserved, the message time slots are assigned exclusively to respective user devices, who proceed without contention. This arrangement is advantageous because the control and signaling messages that may collide can be relatively shorter than arbitrary content messages sent during reserved slots. According to the patent, the recurring frame has a fixed length (a given number of total time slots). The controller can vary the proportion of time slots devoted to control and signaling versus the proportion used for messages. When traffic is high, more signaling slots (contention slots) can be assigned and fewer message slots, and vice versa. This technique devotes more bandwidth to dealing with contention when the probability of collision increases, in a controlled manner. The number of message slots available to a given user device per unit of time decreases when traffic increases, which slows the network from the perspective of a transmitting station.

In time division arrangements and in frequency hopping arrangements, user devices that seek to transmit a packet can vary the frequency of their transmission attempts or the rate of channel hopping, to reduce the chances of repetitive collisions. Slowing the frequency of attempts also slows the network from the senders' perspective.

Message collisions, message acknowledgments, resend-request messages, reservation requests and other such efforts to avoid or ameliorate collisions, expend a portion of the throughput or capacity of the medium. It would be ideal if the throughput could be used solely for transmitting successful messages. As the message traffic increases relative to a maximum level, use of the network tends to shift from a situation in which the greater proportion of the network throughput is devoted efficiently to transmitting successful messages on the first try, to a situation in which more of the possible throughput is expended inefficiently on collisions, or to carry re-sent messages or acknowledgments and the like. With higher and higher traffic levels, messages are more and more likely to collide. The collisions generate yet more contention-related messages, leaving still less throughput available. When traffic is light and collisions are relatively unlikely, pure contention protocols are efficient. However, as traffic increases and collisions are more likely, more and more acknowledgments or corrective messages become necessary, increasing the likelihood of collisions, in a self-feeding manner until the network throughput is choked with contention related transmissions and successful transmissions are virtually stopped.

What is needed is an improved network that permits contention when traffic is light or moderate, so that available bandwidth is used as freely and efficiently as possible (e.g., with minimal contention-related overhead), but which does not tend to deteriorate with throughput-sapping contention and corrective messages when traffic is high.

### BRIEF DESCRIPTION OF THE DRAWINGS

The present invention will become more fully apparent from the following description, appended claims, and accompanying drawings in which:

FIG. 1 is a schematic representation of a shared-resource network in which transmissions from two or more message transmitting units may collide or overlap in time, such as a random access ALOHA network.

FIG. 2 is a plot of the proportion of maximum possible network message capacity (y axis) versus the total message traffic (x axis), normalized by assuming an arbitrary network capacity.

FIG. 3 is a flow chart illustrating operation of the network according to the invention to regulate message traffic under certain circumstances.

FIG. 4 is a time diagram showing one time division multiplex frame in a slotted ALOHA network according to the invention.

FIG. 5 is a plot of probability of successful message transmission as a function of a probability of access factor (PAF) assigned according to the invention.

### DETAILED DESCRIPTION OF THE PREFERRED EMBODIMENT

According to the present invention, such an improved network is provided by arranging to limit the access of contending stations variably, as a function of network traffic. The invention is demonstrated with respect to ALOHA and slotted ALOHA contention signaling, typically used for message packets that often are transmitted in bursts.

A probability of access factor (PAF) is determined in one or more of several ways that are discussed hereinafter. The probability of access factor, preferably, a fraction between zero and one, reflects the extent to which the network has shifted from a situation in which contention is rare (PAF=1.0) to a situation in which most or all of the throughput is expended on contention characterized by collisions, resends, acknowledgments or resend requests, etc. (PAF=0.0).

According to an aspect of the invention, the probability of access factor is imposed on the operation of transmitting stations, at least when traffic exceeds a predetermined level. A respective transmitting station seeking to transmit a message is required to randomize the transmission of its message over a variable number of transmission opportunities according to the probability of access factor, PAF.

In one example, the prospective transmitting device randomizes its transmission over a number of transmission opportunities precisely equal to the reciprocal of the probability of access. Thus if traffic is such that a random transmission has a one third probability of successful transmission, according to this embodiment, the transmitting station randomizes its transmission over three transmission opportunities. The transmitting station can employ a locally generated random seed to choose from three consecutive integers (e.g., 0, 1 or 2) and waits for the corresponding number of transmission opportunities before transmitting.

Randomizing transmissions according to the PAF as described effectively delays the transmission by a time period that is related to the probability of successful transmission versus collision. However the transmitting devices are not required simply to delay by a prescribed amount, which would merely delay rather than reduce the possibility that two simultaneously attempted messages might collide.

There are a variety of specific ways in which the PAF could be applied to randomize transmission attempts over a span determined by the probability of successful transmission. Furthermore, the PAF can be determined by a controller and varied as a function of considerations other than the extent to which the network is loaded.

As a result of introducing a variable transmission probability factor to control the frequency of transmission attempts in a random contention network, transmissions of a given user device (transmitting station) tend to proceed at a lower rate when traffic is high than when traffic is low (due to the partial correspondence between randomization of transmissions over successive periods based on probability of access, versus requiring a delay in transmission). However, the variable probability of transmission based on the PAF reduces the extent to which new messages generate new collisions and new collision related messages, that could tend to congest the network in a self-deteriorating way. Thus the network retains a better level of throughput of successful messages at a given high level of traffic than a network that is not so controlled. The network of the invention is less likely to be choked with collisions and contention messages at a given high level of traffic, than a wholly random (ALOHA) access network.

It is desirable to make substantially full use of the bandwidth and time available for carrying communications over a medium, and to permit as many user devices as possible to communicate over the medium. It is also desirable to minimize the overhead of devices, processing requirements and time needed, so that as high a proportion as possible of the available bandwidth, hardware expense and processing load is devoted to sending messages rather than dealing with contention issues and otherwise controlling the communication system.

FIG. 1 illustrates a communication arrangement generally. A number of user devices 22 share a network resource 24 such as a transmission channel for transmission of messages. In one application, the user devices can be subscriber mobile telephones or two-way pagers or the like, and may communicate data packets via a system controller 26 in the form of a base station using a base transceiver 27. The data packets are sent and received in either direction by the user devices 22, and the base station 27, in a contention network arrangement in which two or more transmitting stations (user devices 22 or base station 27) are capable of attempting to transmit on the same bandwidth at the same time, in which case their messages may interfere. Other sorts of network resources 24, such as wired arrangements and the like, are also possible.

The network resource may be any specific communication functional mode that admits one user at a time such that conflicts or collisions may occur. The resource can comprise one frequency band or to better handle simultaneous users can comprise a number of discrete frequency bands. Discrete frequency bands can be used for the duration of a message or the user devices 22 can jump from one band to another according to some jumping sequence that spreads use over various defined channels. A frequency band can be subdivided into time divisions in a time division multiple access setting. A wide frequency band can be shared by code division multiple access to spread the spectrum in that way. Although there might be many combinations of frequencies and time slots involved, the number of user devices 22 and the activity of the user devices may be sufficiently numerous that collisions occur. Even if there are only two users sharing many combinations, there is a possibility that their messages may collide. This disclosure concerns preventing or minimizing the tendency of message traffic congestion to reduce that capacity of the network to handle successful message transmissions and receptions. Thus the invention is most applicable to situations in which the number of users is comparable to the number of combinations of frequency bands and incremental time periods, so that collisions can become a problem leading to undue congestion and decreased effective message throughput.

In a simple example, the network is a contention network and all the potential transmitting devices act randomly, i.e., seek to transmit when they have data ready to go. Message collisions can be expected to occur at a frequency related to the frequency of attempts, which in turn is related to the number of users 22. The relationship of message throughput to message attempts, and the ratio of message attempts to message collisions, is generally a linear relationship, so long as the load on the network is small compared to its maximum throughput capacity. A received message may have been affected by contention, so acknowledgment messages can be assumed as an example. Redundant or repeat transmissions and acknowledgments are needed after a collision. As the number of users becomes substantial relative to the capacity of the network, collisions become relatively more likely and the resulting retransmissions, then even more likely to be needed, place even more load on the network capacity.

It can further be assumed as an example that receiving units (or perhaps a controller) routinely send back an acknowledgment message to the transmitting device. In that case, each transmission involves two messages. If there is a collision, the retransmission and its acknowledgment represent two more messages. If one of these collides, there are two more, etc. It can be appreciated that if the traffic is such that messages collisions are not unusual, processing resources and hardware elements (e.g., memory queues) may be needed to keep track of transmission successes and failures, to buffer messages to be sent or resent and generally to handle transmission and retransmission.

It is possible to envision a network arrangement as shown in FIG. 1, operated such that contention is minimized by extensive preliminary signaling and/or by channel assignments that permit each user 22 exclusive access to the network resource 24 at particular times. However, it may be at least as efficient to permit collisions to occur and to deal with the consequences, such as acknowledgment messages, error checking and re-send requirements, as it is to provide for reserved times, preliminary message clearance signaling and the like. In this context, the efficiency of the network can be measured by the ratio of messages successfully completed to the theoretical maximum that the bandwidth could carry if it was used 100% of the available time with no contention.

Where user devices 22 contending for a channel or time slot are inclined to transmit data in packets or bursts of packets, it may be efficient to permit stations 22 to transmit on a channel whenever they have data to transmit, recognizing that their transmissions will sometimes overlap at least part of one or more other stations' transmissions, requiring retransmission of both. This technique is implemented in the ALOHA protocol. A user device 22 transmits data in packets, whenever it has data to transmit. A return message is sent back to the transmitting device to acknowledge that the message was received. In a variation of the ALOHA protocol known as “slotted ALOHA,” all messages are in packets of equal size and all messages are synchronized to occur in repetitive time slots.

The random or ALOHA protocol is apt in networks characterized by packet bursts. Channel assignments need not be reserved and the channels are generally available to users. It is unnecessary to attend to reservation arrangements and signaling, which would be an inefficient burden when traffic is relatively light and collisions are not likely.

However, random or ALOHA communications can bog down when the traffic rate is high, e.g., when there are many stations contending to transmit. It is possible to determine a theoretical maximum throughput of an ALOHA network, namely in which transmitting stations transmit randomly and may conflict. Whereas there is no control to prevent messages from colliding and requiring retransmission, the maximum theoretical throughput is less than half of the maximum possible throughput if messages did not conflict. The particular theoretical maximum may vary, for example, as a result of aspects such as whether or not the messages are of a standard length, whether they are synchronized, etc. For example, if the messages are synchronized and are all the same length, then it is only possible to have a collision in the form of fully aligned overlapping messages, as opposed to overlaps between leading and trailing edges.

Message collisions are more likely when the level of traffic is high, than when the traffic is low. During high traffic there is a greater probability and greater occurrence of re-transmissions and additional acknowledgments, resulting in more transmission attempts and potentially more collisions and acknowledgments, building exponentially. In worst case congestion, the entire bandwidth and virtually all the processing capability of the user devices 22 would be devoted to making transmission attempts that are unsuccessful due to collisions involving the original transmission or its acknowledgment message, or a subsequent re-send attempt and its acknowledgment. Throughput is reduced to zero. Message latency (the proportion of messages queued to be sent) rises to 100%.

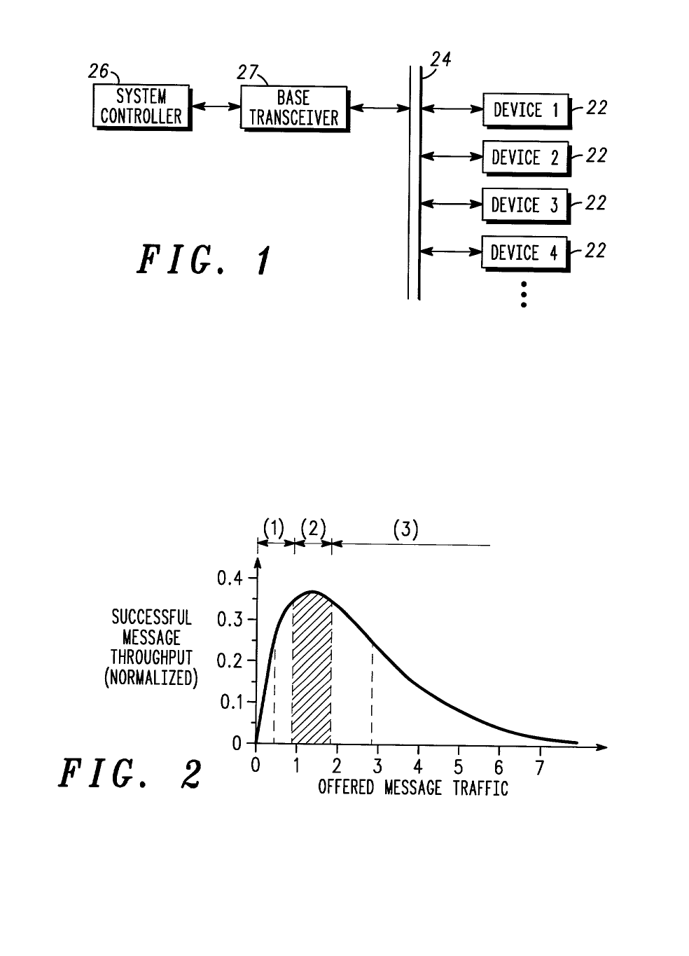

In simple ALOHA and in slotted ALOHA, as well as in other protocols where devices have random access to send, the probability of collisions increases with traffic. This situation can be seen with reference to FIG. 2, which shows successful message throughput (Y Axis) as a function of total offered message traffic (X Axis). The offered message traffic (X) counts an attempted message transmission once, regardless of whether one or more retransmissions were necessary before the message was successfully received and contributed to successful throughput (Y).

The average number of network messages needed to effect the successful transmission of one single offered message increases as the probability of collision increases, and the probability of collisions increases when the traffic exceeds some number that can be readily handled by the network due to its bandwidth and the like. The successful message throughput of the network falls off at high levels of offered message traffic, because a large portion of the throughput that the network could support is being used to recover from the effects of collisions rather than to send successful messages.

In a random access network characterized by contention for messaging as well as those in which contention is limited to control and signaling, there are three general phases, shown in FIG. 2, in which congestion or lack of congestion affect the throughput of network communications differently. In light traffic as shown by phase (1), collisions are relatively rare. The number of successful transmissions is approximately equal to the number of transmissions attempted. Network throughput (number of successful completed messages) in that phase is low because offered message traffic is low. The proportion of successfully completed messages to offered messages is high (nearly 1:1).

If more transmissions are offered per unit of time, for example as more users come on line, the number of offered messages increases and the successful message throughput increases too. However, the likelihood of collisions increases due to the greater traffic as well. Therefore, the network carries more second attempts than in the lighter traffic phase.

Inasmuch as collisions are known to be inherent in the random operation of the network, it may be desirable to make some form of acknowledgment message a routine procedure for notifying a transmitting device that its transmission has been received. The acknowledgment could be a brief acknowledgment of an unspecified message. The acknowledgment also could specify information that assists in making a determination as to whether the message was correctly received, such as a byte count. The acknowledgment can comprise a request for re-send if an error is detected, such as a parity or cyclic redundancy check (CRC) mismatch. Alternatively, the transmitting device can resend routinely if it does not receive an acknowledgment within a predetermined time.

Inherently in such a contention network, the ratio of successful completed message transmissions to total offered message transmissions is highest when the usage of the network is light (stage (1) in FIG. 2). More transmissions are needed per successful completed message transmission, as usage increases and the number of active messages per offered message increases, making collisions more likely to occur. Throughput still increases and at some point reaches a peak successful message throughput (stage (2) in FIG. 2). Each successful transmission may involve one or two messages, such as a transmission or a transmission and an acknowledge back. Assuming there are two messages, either of the messages may collide with a message of another device transmitting on the network. If a collision occurs, at least two more messages result (retransmission and acknowledgment), which also might collide with other messages, leading to further send attempts. As traffic increases, collisions increase. As shown in stage (3) of FIG. 2, throughput falls off from its peak because more of the network throughput carries colliding messages, subsequent retransmission attempts and possible further retransmission attempts after earlier retries that failed due to collisions.

The situation is graphically illustrated in FIG. 2. Specifically, an incremental change in the number of message attempts has a different effect on the total successful message throughput of the network, depending on whether the network is lightly loaded or heavily loaded. The graph of successful throughput versus total attempts has three stages. When loading is light, as represented by stage 1 in FIG. 2, collisions occur rarely. There are many more unused slots than there are messages to send. Probability of access and successful transmission are high. Few messages are queued and waiting to be sent or acknowledged or re-sent, etc. (i.e., message latency is low). In this stage, messages are quickly and easily transmitted, so the load on the battery of portable transmitters is low. But network total message throughput is also low. In this light load stage of operation, the total message throughput is approximately proportional to the number of transmissions attempted, which usually is proportional to the number of users (although other factors such as time of day may also be involved). In this phase, an incremental increase in message attempts results in approximately the same incremental increase in throughput, even though the network is not being used to capacity.

In stage 2, the number of messages attempted per unit of time is high enough that collisions occur with some probability because more of the message slots are occupied with messages. The relationship of message attempts to throughput is no longer proportional, or at least has a progressively lower slope. When messages collide, additional messages become necessary for re-sending and acknowledgment. More messages are necessary on the average, in order to transmit each successful message. In this stage of operation, an incremental increase in message attempts results in increased throughput and increased likelihood of collisions.

At some level of usage in the area of the theoretical maximum throughput, shown in FIG. 2, the slope of the curve of total traffic to proportion of maximum successful throughput becomes negative. That is, with further messages being offered (new attempted message transmissions) the resulting increase in collisions is such that the successful message throughput decreases with increasing offered messages. This areas is shown as stage 3 in FIG. 2. If the traffic in offered messages increases further, a still higher proportion of the attempted messages collide with other messages than in stages 1 and 2. A greater proportion of the active messages are retransmissions attempting to recover from collisions. At some level of traffic overload, the probability of sending a successful message falls to near zero. Most or all of the transmissions being carried are not newly offered transmissions, but are retransmissions after collisions. The messages that are not new offerings generate collisions that require more message traffic, which further increases the probability of collision and resulting need for more potentially colliding messages, until the network is fully occupied with retransmissions that collide. Successful message throughput falls to zero.

It is an aspect of the present invention that such a network can be prevented from advancing far beyond its stage 2 state of best efficiency in FIG. 2, into progressively less-efficient stage 3, by reducing the attempts made by a transmitting unit to send or offer messages, when loading on the network is high.

When traffic increases into stage 3 in FIG. 2, a supervisory controller 26 according to the invention, shown in FIG. 1, exercises one or more forms of control that cause the transmitting devices 22 to act in a manner that produces fewer conflicts. Specifically, the controller 26 causes the transmitting devices to spread their transmission attempts over a number of successive opportunities in a randomized way. Controller 26 prevents the user devices 22 from transmitting fully randomly and without controls, thus restraining the number of attempts made. By preventing attempts to transmit offered messages (messages that are ready to send), the controller makes it less possible for a device 22 to complete a successful message. That result is not unlike the result of a message collision (i.e., in either case an offered message is not sent). However, unlike a message collision, a prevented attempt to send an offered message due to operation of the invention, does not generate additional potentially colliding messages on the network. The network carries a higher proportion of offered messages and successfully completes a higher proportion of offered messages, than a network of the same capacity and at the same traffic load operated randomly.

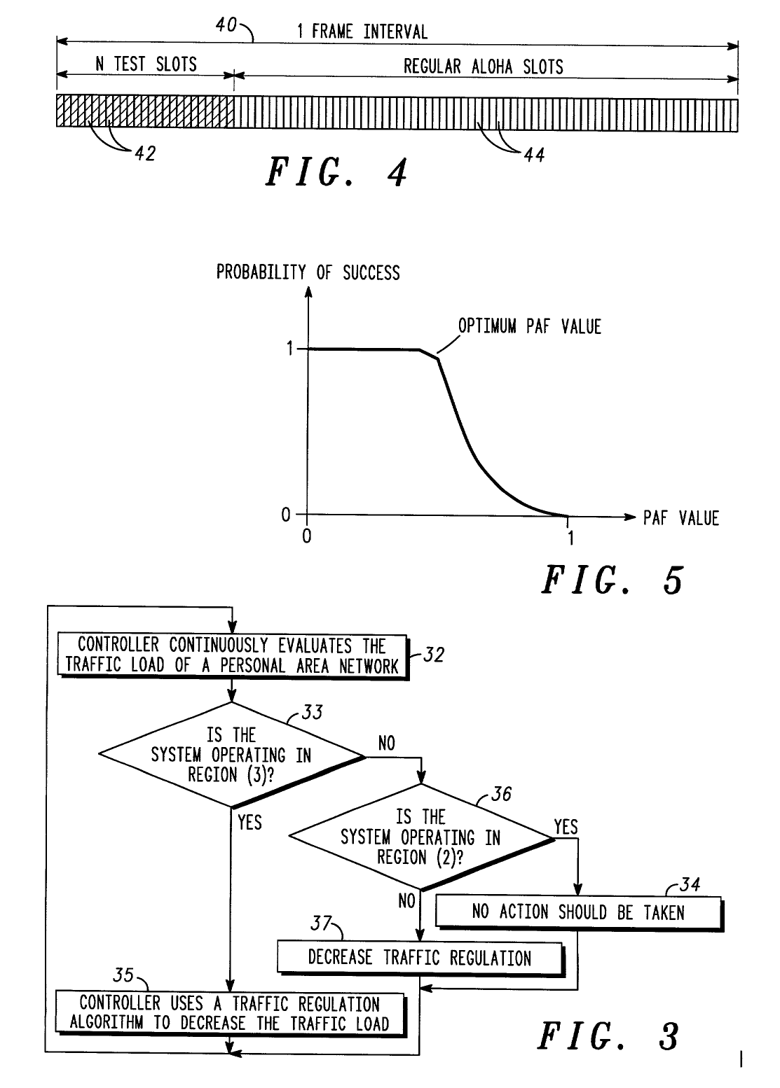

As shown in FIG. 3, at step 32, the supervisory or system controller 26 (see also FIG. 1) continuously evaluates the traffic load on the network. The controller unit can measure the traffic load and at step 33 compares the load to a predetermined value to assess whether the network is operating in stage 1, 2 or 3 as shown in FIG. 2. For example, the supervisory controller 26 may determine the amount of unused time, detect and count the number of unused time slots, or otherwise measure usage. The controller can determine usage over a very short term, or optionally the controller can average the number of unused slots over time to arrive at a running average measure of traffic over a longer term.

If, at step 33, the controller 26 determines that the network is not operating in stage 3 and, at step 36, that network is operating in stage 2, no action is required. The flowchart loops back to step 32 at step 34. if the network is not operating in stage 2 then step 37 decreases any traffic regulations and the process loops back to step 32. The user devices are permitted to continue to randomly attempt message transmissions at any time (or in a slotted arrangement to attempt to transmit during any allowed time slot). The controller may determine that the network is operating in stage 2, which is most desirable in that throughput is at its highest. If the controller determines that the network is operating in stage 3, at step 35 the controller uses one of the traffic control methods discussed hereinafter to decrease the traffic load by causing the units on the network to spread their attempts randomly over a predetermined span, thus attempting transmissions less often on average. This has the effect of reducing the total number of message transmissions attempted and increasing message latency (the number of messages queued to transmit) but without increasing the incidence of collisions.

In stage 3, collisions are relatively likely to produce additional collisions instead of successful messages. By reducing the number of attempts only in stage 3, the network carries more successful messages than it could otherwise; the message latency is shorter than it would have been; and the transmitting devices generally can complete a message successfully in fewer attempts, saving battery life.

As shown in FIG. 3, after step 35 results in action being taken to decrease the traffic load, at least due to collisions, the path loops back to step 32 and possibly again to step 35 to undertake additional action.

The controller 26 detects when the load on the network increases into stage 3, and acts to reduce the network load to bring network operation into stage 2. The object is to reduce the load on the network in such a way that incremental additional messages will not inordinately increase message traffic by unduly increasing the probability of collisions and re-sends. The controller operates in a feedback control mode to detect the extent of overloading and to feed back a control input to devices 22 that reduces the frequency of their transmission attempts as a function of the extent of overloading.

In order to determine the appropriate PAF to be applied, the controller 26 preferably assigns a variable number of test slots (see FIG. 4) to be used for test messages submitted by user devices that have information to send. Each respective user device can be required to submit a test transmission during one of the test slots whenever the user device has a message ready to send. Alternatively, the test messages may be required as soon as a user device knows that a transmission is intended or is impending (i.e., soon to be ready to send). The user devices insert their test messages randomly into any of the test slots. The controller 26 monitors the extent to which the test slots become filled with transmissions. A test slot is “filled” if at least one transmission occupies it. It is possible that the test slot may be chosen by two devices whose test messages collide, but the controller need only take notice that the slot has been used. If relatively more or fewer of the test slots become used, the controller can conclude that the proportionate use of the network corresponds to the extent of test slot usage. Although some of the test slots may have been used by one prospective transmitting device and another of the test slots may have been used by two or more in a collision, the usage of the test slots still generally corresponds to usage of the network throughput up to a level of usage at which there are so many transmitting devices that all the test slots are used by one or more potential transmitting devices.

However, in a preferred arrangement, the controller 26 can vary the number of slots devoted to use as test slots. In that event the controller can signal to the user devices how many slots are available and/or where the test slots are located in the frame. Thus if the controller has assigned N test slots at the beginning of a frame, which have been determined (e.g., empirically) to represent usage from zero to X % of throughput capacity, and traffic increases until they all are used (i.e., the network is operating at capacity X %), the controller may assign additional test slots and thereby change the range represented by the test slots to Y %, where Y is greater than X. This increases the extent to which the total number of slots in a frame are used for signaling, thereby reducing the number available for messages, but enables representation of a larger number of users or a larger range of usage.

In FIG. 2, stage 2 as shown by the shading under the curve bracket is an area in which successful message throughput is within approximately 90% of the theoretical maximum. The precise boundaries between the stages are somewhat arbitrary. It is also possible to operate on a wider stage 2, such as 60% of the theoretical maximum, shown in the outer bracketing dash lines in FIG. 2, or at some other figure. It is also possible to increase the stringency of the controls effected by the controller 26, as a function of how far along the stages the network operation has progressed.

In a preferred arrangement, when the system controller 26 detects that the traffic load (number of messages being attempted) is in stage 3, the controller 26 attempts to regulate the traffic sufficiently to reduce traffic to operation in stage 2. Traffic regulation can be accomplished in one or more of several ways. According to one inventive method, the supervisory controller 26 signals to all devices 22 a “Probability of Access” factor or measure. This factor is based on an assessment from the controller 26 as to the level of usage of the network, and that translates generally into a measure of how likely it is that a newly offered message attempt will result in a successful message completion.

In stage 1 of FIG. 2, where collisions are unlikely, the probability of access is near unity. For example, if the probability is measured on a scale of ten, a PAF of ten could indicate a probability of 100% that an attempted transmission would result in a successful transmission. Only a small number of slots, if any, need to be reserved as test slots to measure the extent of network usage, because the usage is light. Preferably, a high PAF signals devices 22 to signal randomly, as soon as a message is ready to send, in the usual ALOHA or slotted ALOHA manner. A PAF of five on a scale of ten (probability 50% or ½), indicates to devices 22 that there is a 50:50 chance of success if transmission is attempted immediately.

It is an aspect of the invention that the devices 22 restrict their transmission attempts as a function of the reported PAF value, in a manner that spreads their transmission attempts over a span of time or time slots that is generally shorter if the PAF is relatively higher (i.e., representing a higher probability of successful transmission) and generally longer if the PAF is relatively low. More particularly, according to an inventive aspect, the devices 22 are provided by signals from controller 26 with a variable measure that at least partly represents the probability of access (PAF). The protocol requires at least some and preferably all of the transmitting devices to restrict or spread their transmission attempts by randomizing their transmission attempts over a number of transmission opportunities, which number is inversely proportional to the probability of successful transmission represented by the PAF value.

Importantly, the invention as described does not adversely affect the successful message throughput or latency experience from the perspective of the user device 22 which is required by the protocol to randomize or similarly spread out its message attempts as a function of traffic load. On the contrary, the invention effectively improves the use of the throughput for successful messages under high traffic conditions. Other things being equal, the invention will allow a given device to maintain a lower latency than it could otherwise achieve at the same level of network traffic crowding.

For example, if the reported probability of access factor PAF accurately represents probability (which is preferred but not absolutely necessary), and assuming that usage is such that the probability and the PAF are exactly 50%, then an immediate transmission attempt is 50% likely to succeed and 50% likely to fail. If device randomizes its attempts according to the same probability figure, namely randomizes its attempts over the next two opportunities if the PAF represents 50%, then the device experiences the same effect on throughput and latency as it would have experienced from making a transmission attempt. The difference according to the invention is that by restricting itself instead of being restricted by collisions, the device 22 has not contributed to the overloading of the network when it might have transmitted but did not transmit. By abstaining during a given opportunity, the device 22 has not produced a collision requiring a retransmission and an acknowledgment and possibly further retransmission(s) and acknowledgment(s) if necessary in view of further collisions. According to the invention, heavy traffic tends to slow down throughput over the network, but does not slow down the traffic to the same extent that collisions would slow the same level of traffic.

Assuming that the PAF is represented by a scale of ten, if the PAF is 10, then device 22 transmits immediately. If the PAF is 5, device 22 randomizes its transmission over two opportunities. If the PAF is 1, device 22 randomizes its transmission over ten opportunities. This same technique can be expanded to any scale or number of opportunities.

By randomizing the transmission over a certain number of opportunities, device 22 can determine when to attempt a transmission over a number of impending opportunities and then make the attempt when that opportunity arrives. For example, if the PAF is 50% (five on a scale of ten), then device 22 can randomly select one of the two next slots or opportunities to send its packet. If the PAF is 10%, device 22 can randomly select one of the next ten slots in which to send. In either case, device 22 counts opportunities until the randomly selected one arrives and then attempts a transmission.

With a 10% PAF, after transmitting in its selected one of ten slots, for example, the device may be required to wait until the remainder of the ten slots have passed before considering another transmission. With a 50% PAF, after transmitting in one or two slots or five of ten slots, etc., the device may need to wait out the radix number of two or ten, etc., before it can consider a new transmission. Alternatively, randomizing could be effected on a slot by slot basis.

Thus in the foregoing example of a 50% PAF, device 22 could apply a 50% random selection to choose one of the two next slots. The device might randomly pick the immediate next slot as the one in which to transmit and if so could be required by the protocol to wait during the following slot until the radix number of slots (two in this example) had passed. The device also might randomly pick the second next slot instead of the immediate next slot, and would wait one slot, transmit one slot and be available to reconsider immediately because the radix number of slots had passed. In this arrangement, the 50% PAF might involve one of two or two of four or three of six, etc. At least one chosen slot(s) in the radix number always would be used, and the device would wait out the remainder of the radix number if necessary (i.e., if the chosen slot(s) did not include the last in the radix).

Alternatively, the random selection probability factor could be applied to every arising slot. This method would be similar to successive random choices like flipping a coin, wherein the probability for each selection may be 50% but the probability applies to each time that the coin is flipped. There are various ways in which such a probability could be applied, for example collecting a random or pseudo-random seed such as the least significant bits of a free running clock counter and proportioning the seed to the radix value.

In such an arrangement where attempts are made based on a PAF, network congestion reduces the rate at which the terminals can send successful messages or packets, just as congestion would in an unregulated network moving into stage 3 of FIG. 2. However, unlike the unregulated network, the invention improves the efficiency of the network in terms of total messages transmitted successfully and thus tends to carry a higher message rate than an unregulated network at times of high traffic.

According to an alternative or additional embodiment for regulating the rate at which terminals attempt to send, some terminals can be accorded a higher priority than others. Such distinctions could be based on message size, the type of transaction, the possible emergency nature of a transmission, or even the type of service whereby premium service has a higher priority than normal.

For example, priority can be accorded to those terminals that have made more unsuccessful attempts than others. For example, after making three (or some other number) of unsuccessful attempts, a device 22 might assume a PAF of one, whereas a terminal making its first attempt on a newly offered message would have a lower PAF, such as 0.1, and would randomize its send attempts over a longer span of opportunities (i.e., choosing one opportunity from among the next ten or else making a one-in-ten randomized decision for each opportunity until a decision is made to attempt to send.

In the foregoing regulation schemes, the network message latency increases when the network is in stage 3, because terminals are required to delay their attempts to transmit. However the efficiency of the network is better than an unregulated network. As a result, the latency will be lower than in an unregulated network operating at the same message demand level.

In order to determine the optimal PAF factor, it is necessary to assess the load on the network. As mentioned above, the supervisory controller may monitor for and count unused time slots as one technique. FIG. 4 illustrates another technique. According to this embodiment, the controller 26 reserves N test slots 42 out of a repetitive frame interval 40 that comprises the test slots 42 and a plurality of regular ALOHA time slots 44. All the terminals 22 are informed about the location of the test slots and are synchronized to the time slots in the successive frames, which can be by broadcast information from a supervisory controller or by preprogramming of the terminals. The N test slots are for use by all the transmission units, such as wireless subscriber units, which are ready to establish a communication link over the network, for example with a base station that functions as the supervisory controller.

The N test slots enable the controller 26 to determine a PAF factor within a certain level of precision, and to assign it to the terminal devices 22. A terminal that establishes communications with the base station (or similar supervisory controller) can send a packet in any of the test slots. The appropriate PAF will by 1.0 if none of the slots are used. The PAF will be some minimum probability if all of the slots are used. However the controller can be arranged to assign more or fewer test slots to be used or not used as a measure of traffic level, as discussed above.

The same PAF value can be assigned to all the terminals that are seeking to transmit. Or the PAF value can be applicable to all the terminals that establish communications in preparation to send and receive message packets. FIG. 5 illustrates the aspect of the invention that a single PAF value can be selected and used to distribute rights that reduce the frequency of attempted transmissions by the terminals, specifically by causing the terminals to randomize over a preset number of opportunities. The PAF value is related to the probability of successfully transmitting a message, according to a relationship that reduces the frequency of transmission attempts as the probability of success lessens.

FIG. 5 illustrates a relationship between probability of success and the PAF value used. An object of the control is to seek an optimum PAF value as shown. Preferably the network is operated as near as practicable to its peak throughput level when tending to move into stage 3 of FIG. 2.

The invention is particularly applicable to slotted ALOHA protocol time division multiple access mode, which is apt for cellular phone, pager and other wireless communication networks. For example, the invention is applicable to ReFLEX and many other wireless protocols (e.g,. iDEN, GSM). The invention is also applicable to a network in which test slots and/or a supervisory controller are not employed to allocate resources by assigning probability or priority or otherwise adjusting the frequency of transmission attempts. This can be accomplished by the protocol under which the transmitting units operate. Thus, the ALOHA access rate can be optimized without the use of test slots, namely by monitoring the usage of the regular ALOHA test slots themselves. This protocol does not require changes to ReFLEX receivers, the IPP receiver-controller protocol or to ReFLEX pagers.

The mobile subscriber units practice a regular ALOHA protocol in contention with other units, preferably but not necessarily slotted ALOHA. Each receiver (including each mobile unit) monitors all the ALOHA slots (or otherwise assesses the extent of traffic on the network). Slots received as noise are considered empty and available. Slots that are received and decoded without error are considered occupied by successful messages (regardless of whether the intended receiver successfully received the message). Slots that contain transmission energy or are partly decoded with errors are considered to represent collisions. With this information regarding the ratios of used, available and collision slots, a supervisory controller can select an optimal operating point and signal the transmitting units if necessary to reduce the frequency of transmission attempts.

It has been found that the ratio R_{C} of the number of collision slots to the total number of slots is a monotonic function and is somewhat linear in the desired region of operation (stage 2 in FIG. 2) where throughput is at its maximum. The number of total slots can be varied to change the ratio of the number of collision slots to the total slots for subscriber devices that make an attempt after every so many slots in a frame as dictated by a PAF that is calculated or assigned to each subscriber device. More slots are made available (the frame is lengthened to more total slots) to reduce the traffic load, namely to cause fewer collisions and thus fewer retransmissions and further collisions.

A desired operating point specified by a given ratio R_{C} of collision slots to total slots is beneficial because it refers to a quantity that is directly (negatively) correlated to throughput. The ratio R_{C} is a measure of the transmissions that are not successful due to collision. The allocation of resources, assignment of PAF priority factors and the like can be varied to control the network to seek an operating point having a given ratio R_{C}. The ratio R_{C} is not variable, for example, due to changes in capture ratio or macro-diversity, even by a factor of two, and thus is a robust control measure.

It will be understood that various changes in the details, materials, and arrangements of the parts which have been described and illustrated above in order to explain the nature of this invention may be made by those skilled in the art without departing from the principle and scope of the invention as recited in the following claims.

What is claimed:

1. A data communication system comprising:
at least one communication channel accessible to a plurality of message transmitting stations wherein said message transmitting stations access the channel according to a protocol in which at least two of the message transmitting stations can access the channel and attempt to transmit messages that collide by at least partly overlapping in time;
wherein the transmitting stations are governed by a probability of access factor such that said transmitting stations reduce a frequency of transmission attempts made by said transmitting stations when the probability of access factor indicates that a successful message is relatively less likely, and increase the frequency of transmission attempts when the probability of access factor indicates that a successful attempt is more likely;
whereby incidence of message collisions is reduced in high traffic operation, achieving improved throughput of successful message transmissions.

2. The data communication system of claim 1, wherein the transmitting stations transmit messages during discrete time slots, and wherein a plurality of test message slots are reserved among said time slots for test messages.

3. The data communication system of claim 1, further comprising a supervisory controller operable to establish discrete time slots for transmission of messages by the transmitting stations.

4. The data communication system of claim 3, wherein the discrete time slots include a plurality of test message slots reserved among said time slots for test messages.

5. The data communication system of claim 4, wherein transmission during particular ones of the test message slots determines a permitted probability of message transmission by the transmitting stations.

6. The data communication system of claim 5, wherein the test message slots occur in an order defining a probability of access factor and the transmitting stations vary said probability of message transmission based on the probability of access factor.

7. The data communication system of claim 6, wherein the test message slots are contention slots and define said probability of access factor when successfully captured by one of the transmitting stations.

8. The data communication system of claim 1, further comprising a controller operable to assess usage of the channel and to signal the transmitting stations for adjusting priorities of messages of the transmitting stations when the usage exceeds a predetermined high threshold, by signaling a probability of access factor determining a probability of message transmission by the transmitting stations.

9. The data communication system of claim 8, wherein the controller is inactive when the usage is less than a predetermined low threshold.

10. The data communication system of claim 1, wherein the transmitting stations are operable to randomize attempts to transmit over a number of opportunities as dictated by the probability of access factor.

11. The data communication system of claim 1, wherein the transmitting stations are operable to signal a requested priority for a given message and the controller is operable to adjust the probability of access factor in response to signals from the transmitting stations.

12. The data communication system of claim 11, wherein the controller is operable to adjust priorities among messages from the transmitting stations by defining repetitive test time slots in which the transmitting stations can signal intent to send a message, and signaling a probability of access factor over the network by signaling the transmission stations based on use of the test time slots.

13. The data communication system of claim 12, wherein the controller defines a plurality of said test time slots, and wherein a position of a given one of the time slots in said plurality representing a message priority.

14. The data communication system of claim 1, wherein the transmitting stations are operable to assume different transmission power levels, whereby selected transmitting stations employing a relatively higher transmission power level are more likely to prevail in a message collision than those employing a relatively lower transmission power level.

15. A method for regulating communications in a system wherein transmitting stations share at least one communication channel and messages from the transmitting stations can collide by overlapping in time, requiring at least one of retransmission and processing, the method comprising:
defining an operational throughput of the communication system having a given likelihood of collisions of the messages;
detecting when the communication system has a throughput at and above said operational throughput having said given likelihood;
restricting transmission of messages by the transmitting stations when the throughput is at and above said operational throughput having said given likelihood.

16. The method of claim 15, wherein said restricting transmission comprises signaling the transmitting stations an indication of a probability of access, and wherein the transmitting stations time message transmission attempts as a function of at least one of a message priority and said probability of access.

17. The method of claim 15, comprising reserving a plurality of message test time slots for use by transmitting stations intending to transmit, and wherein the probability of access is at least partly a function of usage of the message test time slots.

18. The method of claim 15, wherein the transmitting stations transmit a selected message priority by selecting ones of the message test time slots.

19. The method of claim 15, wherein the controller is operable to command the transmitting stations during periods of high activity to adjust their transmitting power as a function of priority, whereby transmitting stations having higher priority messages transmit at higher power than those with lower priority messages and are better inclined to prevail in a collision.

20. The method of claim 15, further comprising coupling a controller to adjust the indication of probability of access when average traffic exceeds a predetermined high threshold.

21. The method of claim 15, wherein the controller is inactive to adjust the indication of probability of access when average traffic is less than a predetermined low threshold.

22. The method of claim 15, further comprising adjusting the indication of probability of access to achieve a predetermined relationship of message collisions to total message attempts.

23. A user terminal arranged to operate on a communication channel together with a plurality of other user terminals, wherein said user terminals access the channel according to a contention protocol in which two of the user terminals can attempt to transmit messages that collide by at least partly overlapping in time, comprising
a transceiver, and
a controller, coupled to the transmitter, arranged and constructed to control the transceiver in accordance with a probability of access factor such that a frequency of transmission attempts is decreased when the probability of access factor indicates that a successful message is relatively less likely, and increased when the probability of access factor indicates that a successful attempt is more likely;
whereby incidence of message collisions is reduced in high traffic operation, achieving improved throughput of successful message transmissions.

24. The user terminal of claim 23, wherein the transmitter transmits messages during discrete time slots, and wherein a plurality of test message slots are reserved among said time slots for test messages.

25. The user terminal of claim 24, wherein transmission during particular ones of the test message slots determines a permitted probability of message transmission by the transceiver.

26. The user terminal of claim 23, wherein said transceiver receives a signal including the probability of access factor used to determine a probability of message transmission by the transceiver.

27. The user terminal of claim 23, wherein the transceiver and controller are operable to randomize attempts to transmit over a number of opportunities as dictated by the probability of access factor.

28. The user terminal of claim 23, wherein the transceiver is operable to signal a requested priority for a given message and the controller is operable to adjust the probability of access factor.
